(19) United States
(12) Patent Application Publication
(10) Pub. No.: US 2012/0014765 A1
(43) Pub. Date: Jan. 19, 2012

(54) FRAC NUT AND METHOD OF USING

(75) Inventor: Jason Wayne Ries, Valparaiso, IN (US)

(73) Assignee: R-TECH, INC., Winamac, IN (US)

(21) Appl. No.: 13/184,980

(22) Filed: Jul. 18, 2011

Related U.S. Application Data
(60) Provisional application No. 61/364,867, filed on Jul. 16, 2010.

(51) Int. Cl. F16B 37/08

(52) U.S. Cl. 411/433

(57) ABSTRACT

A frac nut assembly and method of using the assembly. The assembly has an annular shape, an outer circumferential surface, an interior surface having female threads thereon at one axial end of the frac nut assembly and a shoulder that extends radially inward from an opposite axial end of the frac nut assembly, and at least two lugs radially protruding from the outer circumferential surface. The frac nut assembly further comprises at least two members that define the frac nut assembly when assembled together at planar radial interfaces.

### CROSS REFERENCE TO RELATED APPLICATIONS

This application claims the benefit of U.S. Provisional Application No. 61/364,867, filed Jul. 16, 2010, the contents of which are incorporated herein by reference.

### BACKGROUND OF THE INVENTION

The present invention generally relates to methods and devices for connecting tubing or pipelines, and more particularly for tubing or piping adapted to connect liquid storage tanks.

Wide varieties of liquid storage tanks are employed in various industries. A frac tank is a particular example of a storage tank that was developed for the drilling and oil field industries and has found uses in various other fields where containment of a material is important for safety and environmental reasons. Frac tanks typically have liquid capacities in excess of 10,000 gallons (about 40,000 liters), and may be equipped with wheels to facilitate the transport of the tank between job sites. Their large capacities, mobility, and rugged designs make frac tanks well suited for storing a variety of liquids.

To expand the storage capacity at a job site, multiple frac tanks are often connected in series with hoses (or other suitable fluid conduits) that permit individual tanks to be filled and closed as circumstances may require. Such hoses are connected to port fittings of the fac tanks with fasteners commonly referred to as frac nuts. Frac nuts generally resemble a conventional annular-shaped one-piece nut with female threads defined on its interior bore, but with the addition of a radially-inward projecting shoulder at one end of the bore. The shoulder of a frac nut is adapted to capture and bear against an annular flange formed on the port fitting of a frac tank for the purpose of permanently retaining the frac nut on the tank. Hoses adapted to be connected to a frac tank are equipped with fittings provided with male threads that are complementary to the female threads of the frac nut. Frac nuts are also adapted to secure a cap to the tank port fitting to permit transporting of the tank. Frac nuts can have a wide range of sizes depending on the pipe size, such as nonlimiting examples of 4, 6 and 8 inches (about 10, 15 and 20 cm).

A conventional frac nut typically has lugs that extend radially from its outer circumference that enable the nut to be rotated by impacting with a hammer or other tool. Even so, frac nuts can be difficult to remove due to contamination by the liquid stored in a tank, corrosion and various other environmental conditions.

### BRIEF DESCRIPTION OF THE INVENTION

The present invention provides a frac nut assembly and method of using the frac nut assembly, wherein the frac nut assembly is configured to be readily removable from a frac tank.

According to a first aspect of the invention, the frac nut assembly has an annular shape, an outer circumferential surface, an interior surface having female threads thereon at one axial end of the frac nut assembly and a shoulder that extends radially inward from an opposite axial end of the frac nut assembly, and at least two lugs radially protruding from the outer circumferential surface. The frac nut assembly further comprises at least two members that define the frac nut assembly when assembled together at planar radial interfaces. Each of the members has an arcuate shape that forms a portion of the annular shape of the frac nut assembly, a radially outward surface defining a portion of the outer circumferential surface of the frac nut assembly, a radially inward surface having a shoulder fragment thereon that defines a portion of the shoulder of the frac nut assembly and thread fragments thereon that define a portion of the female threads of the frac nut assembly, at least two lug portions radially protruding from the radially outward surface thereof at opposite ends of the arcuate shape of the member so that when the members are assembled the lug portions define at least two of the lugs of the frac nut assembly, and two planar radial surfaces that are partially defined by the lug portions and are complementary to each other to define the planar radial interfaces of the members. Finally, the frac nut assembly includes means for fastening the lug portions of the members together.

According to a second aspect of the invention, the frac nut assembly can be used to secure a fluid conduit to a port fitting of a frac tank. The method includes positioning the members around the port fitting, and then assembling the members together to form the frac nut assembly and so that the frac nut assembly is retained on the port fitting with a flange of the port fitting. A fluid conduit can then be threadably connected to the port fitting by threading a male threaded fitting of the fluid conduit into the female threads of the frac nut assembly.

A technical effect of the invention is the ability of the frac nut assembly to be more readily removable from a port fitting of a frac tank. As with conventional frac nuts, the frac nut assembly of this invention can be used to connect and disconnect a hose and its fitting to a frac tank with the use of a hammer or other large tool by tapping on the lugs of the assembly to cause the assembly to rotate. In the event that the assembly is difficult or impossible to remove from a frac tank, for example, the assembly is seized to a hose fitting as a result of corrosion, contamination by the liquid stored in a tank, or various other possible environmental conditions, the members of the assembly can be disassembled from each other. Such a capability is in contrast to a traditional one-piece frac nut, which if seized to a hose fitting is not removable from a frac tank as a result of the frac nut being captured on the frac tank fitting by the presence of the shoulder of the frac nut and the flange of the frac tank fitting. Consequently, removal of a seized frac nut traditionally requires shutting down the entire frac tank network (which often includes multiple tanks plumbed together through the frac assembly), emptying the tank if it contains a combustible fluid, possibly moving the tank to a safe location for repair, cutting off the tank port fitting, removing the frac nut from the fitting, installing a new frac nut on the fitting, welding the fitting to the frac tank, and then putting the frac tank back into service. As a result, it should be apparent that multiple-piece frac nuts of the present invention have the potential for saving considerable time and expense in the event that the frac nuts become seized.

Other aspects and advantages of this invention will be better appreciated from the following detailed description.

### BRIEF DESCRIPTION OF THE DRAWINGS

FIG. 1 is a perspective view of a frac nut assembly in accordance with an embodiment of the invention.

FIGS. 2, 3 and 4 are top, end and side views of the frac nut assembly of FIG. 1.

FIGS. 5, 6 and 7 are left side, end and right side views of one of the members of the frac nut assembly of FIG. 1.

FIG. 8 is a cross-sectional view of the frac nut of FIGS. 1 through 7 assembled with a sleeve of a frac tank port fitting.

FIG. 9 is an end view of a frac nut assembly in accordance with a second embodiment of the invention.

### DETAILED DESCRIPTION OF THE INVENTION

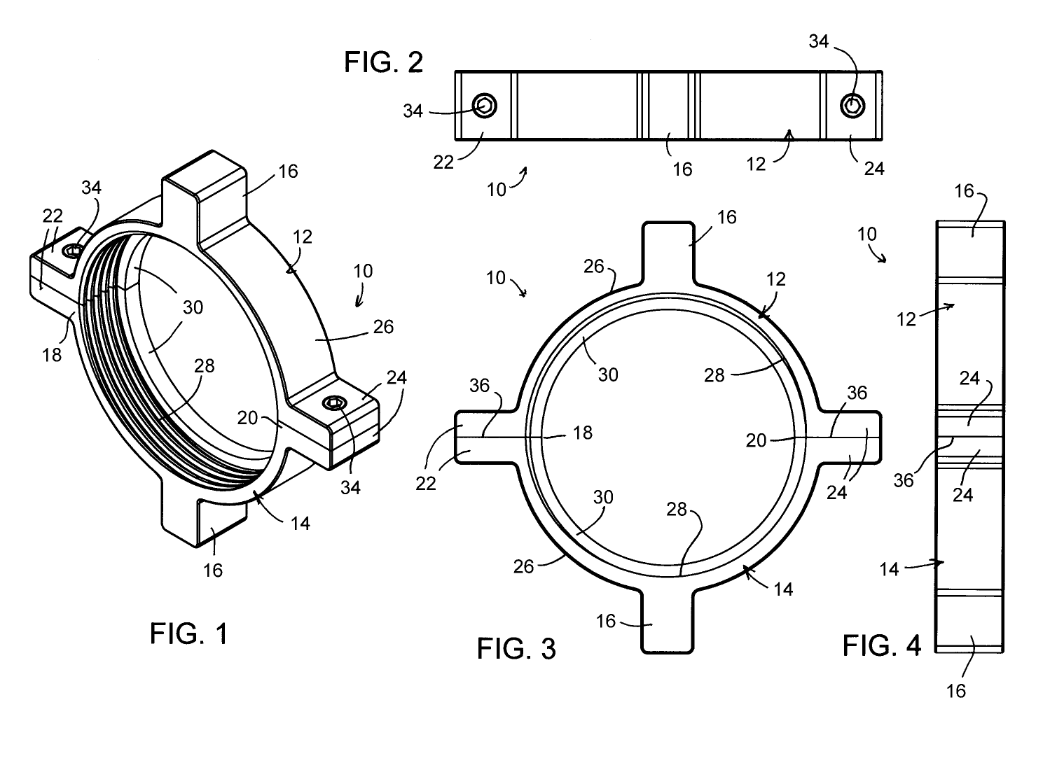

FIGS. 1 through 8 represent a frac nut assembly 10 according to an embodiment of the present invention. The assembly 10 has an annular shape comprised of two entirely separate members 12 and 14, represented as halves of the assembly 10, such that each member 12 and 14 has an arcuate shape that roughly defines a 180 degree arc. Each member 12 and 14 has a full-lug 16 located midway between the extremities 18 and 20 of its arc (i.e., at about 90 degrees), and half-lugs 22 and 24 located at the arc extremities 18 and 20, respectively. The full-lugs 16 and half-lugs 22 and 24 extend radially from the outer circumference 26 of the assembly 10, which is defined by the radially outward surfaces of the individual members 12 and 14 when assembled. The interior circumference of the assembly 10 has threads 28 for threadably engaging male threads (not shown) conventionally provided on a fitting of a hose or other suitable fluid conduit (not shown). As a result, the radially inward surface of each member 12 and 14 has a thread fragment that, when the members 12 and 14 are assembled, cooperate to define the complete threads 28 of the assembly 10. The threads 28 are not continuous along the entire axis of the interior circumference, but instead are limited to one axial end of the assembly 10 and axially terminate at a shoulder 30 that is located at an opposite axial end of the assembly 10 and extends radially inward from the interior circumference of the assembly 10. As such, the radially inward surface of each member 12 and 14 also defines a fragment of the shoulder 30 so that, when the members 12 and 14 are assembled, the fragments define the entire shoulder 30 of the assembly 10.

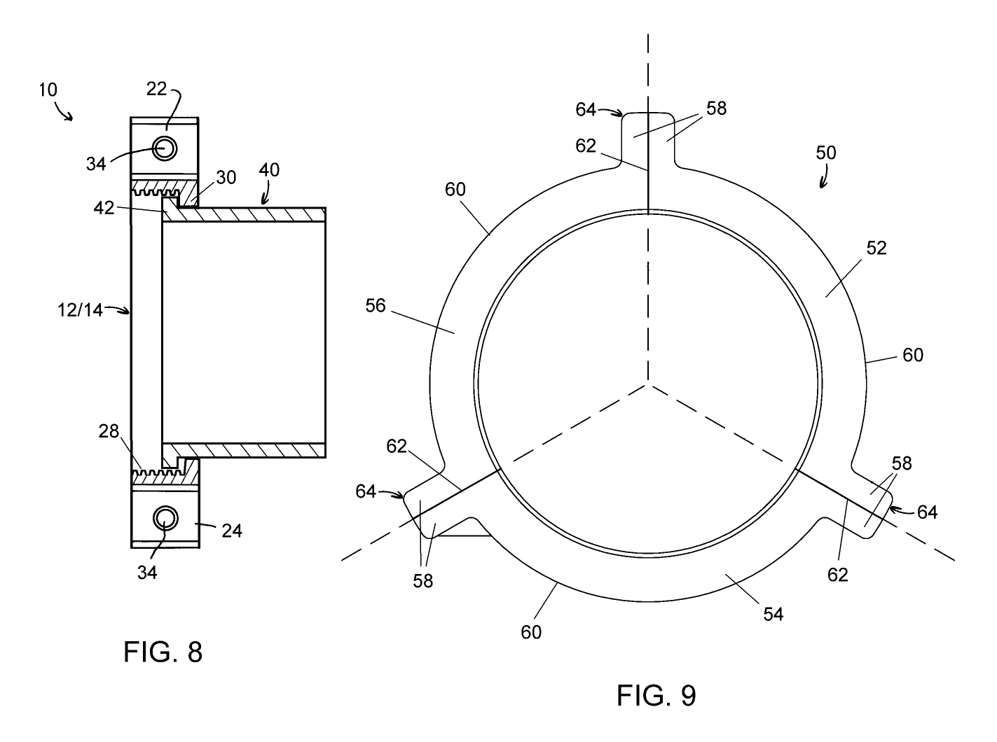

As represented in FIG. 8, the shoulder 30 of each member 12 and 14 is adapted to engage a radially-extending flange 42 at one end of a tube or pipe 40 that forms part of a frac tank port fitting. In practice, the pipe 40 is often in the form of a sleeve that is welded or otherwise attached to the structure that forms a port fitting (inlet and/or outlet) of a frac tank. By positioning the members 12 and 14 around the pipe 40 and then assembling the members 12 and 14 to form the frac nut assembly 10, the shoulder 30 of the assembly 10 and the flange 42 of the pipe 40 cooperate to effectively capture the assembly 10 on the pipe 40. The male threads of a hose fitting (not shown) can then be threaded into the female threads 28 of the assembly 10 to connect the hose to the pipe 40 and, consequently, the interior volume of the frac tank. In a similar manner, the female threads 28 of the assembly 10 are also adapted to secure a cap (not shown) for the purpose of closing the tank port fitting and permit transporting of the tank.

Because of their general shape, the members 12 and 14 are nearly duplicates or mirror images of each other. For example, their full-lugs 16 and half-lugs 22 and 24 can be (and are preferably) identical to each other. Their shoulders 30 are also preferably identical. However, the members 12 and 14 must differ, at least in terms of their threads 28, in order for their threads 28 to circumferentially align when the members 12 and 14 are mated to form a continuous female threaded form within the assembly 10.

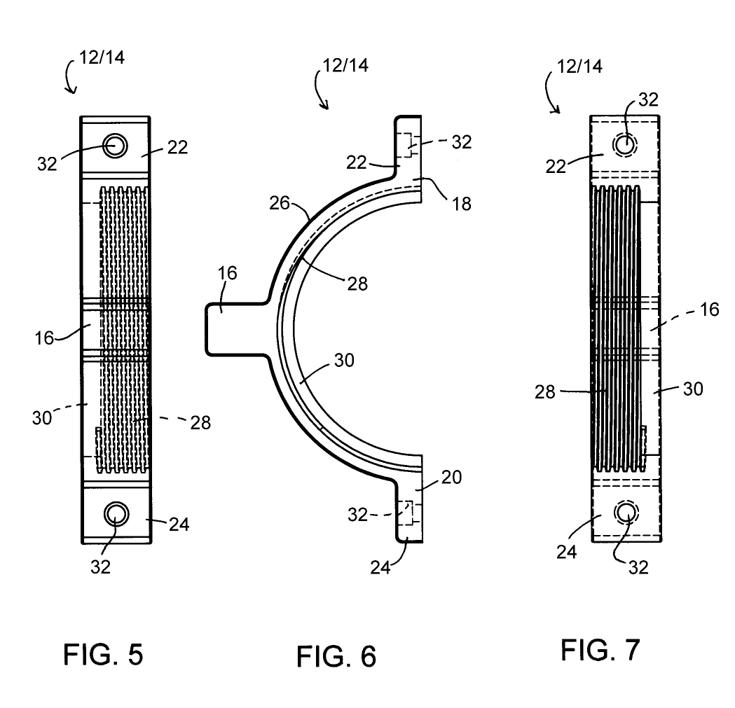

The half-lugs 22 and 24 of the members 12 and 14 are mutually configured to permit assembling and securing of the members 12 and 14 together to form the assembly 10. Each half-lug 22 and 24 is provided with a through-hole 32 (FIGS. 5-7) so that each pair of through-holes 32 defines a bolt hole that permits the members 12 and 14 to be secured together with bolts 34 (FIGS. 1 and 2). The full-lugs 16 and the “composite” lugs formed by each pair of half-lugs 22 and 24 extend radially from the outer circumference 26 of the assembly 10 to enable the assembly 10 to be rotated with a hammer or other tool for the purpose of disconnecting a hose (or removing a cap) from the frac tank pipe 40. Notably, the heads of the bolts 34 are recessed within the through-holes 32 and completely beneath the surfaces of the half-lugs 22 and 24 so as not to interfere with a hammer that is being impacted against the half-lugs 22 and 24. In addition, the assembly 10 can be disassembled from the pipe 40 by removing the bolts 34 to completely disassemble the assembly 10.

The half-lugs 22 and 24 of the members 12 and 14 are also mutually sized and oriented to facilitate the rotation of the assembly 10 through impacts with a hammer or other heavy tool. In particular, the half-lugs 22 and 24 of each member 12 and 14 define a portion of a planar radial surface, and the planar radial surfaces of the members 12 and 14 are complementary to define a planar radial interface 36 between the members 12 and 14 when mated to form the assembly 10. Notably, the planar radial surfaces defined by the half-lugs 22 and 24 uniformly mate in a surface-to-surface manner over their entire surfaces, starting at their innermost radius at the shoulder 30 and terminating at their outermost radius defined by the radially distal end of each half-lug 22 and 24. As a result, the impact of a hammer against one half-lug 22 or 24 is uniformly distributed to the second half-lug 22 or 24 of the same pair, and also transmitted to the threaded interface between the assembly 10 and a threaded port fitting of a tank. Furthermore, the planar radial interface 36 lies on a diameter of the assembly 10 so that the torque delivered to the assembly 10 is maximized by a hammer traveling in a direction generally tangential to the outer circumference 26 of the assembly 10.

Various materials and processes can be used to manufacture the members 12 and 14. The assembly 10 can have a wide range of sizes that will depend on the size of the pipe 40 and the hose fitting to which it is to be connected. Nonlimiting examples are come 4, 6 and 8 inch (about 10, 15 and 20 cm) sizes used in the industry. Suitable axial lengths for the assembly 10 will also depend on the size of the pipe 40 and hose fitting. The threads 28 are preferably ACME threads. For an 8-inch application, a suitable thread 28 has a pitch of about 0.354 inch (about three threads per inch).

FIG. 9 represents a frac nut assembly 50 according to another embodiment of the present invention. The assembly 50 of FIG. 9 is similar to the assembly 10 of FIGS. 1 through 8, with the most notable difference being that the annular shape of the assembly 50 is comprised of three entirely separate members 52, 54 and 56, represented as thirds of the assembly 50, such that each member 52, 54 and 56 roughly defines a 120 degree arc. As a result, the planar radial surfaces of the members 52, 54 and 56 and the planar radial interfaces 62 they define lie on different radials of the assembly 10 set about 120 degrees apart. Each member 52, 54 and 56 has a pair of half-lugs 58 that are located at its arc extremity and extend radially from the outer circumference 60 of the assembly 50 (defined by the assembled members 52, 54 and 56) to define three composite lugs 64 that serve as the only lugs of the assembly 50. As with the assembly 10 of FIGS. 1 through 8, the interior circumference of the assembly 50 has threads (not shown) for threadably engaging male threads conventionally provided on a fitting of a hose adapted to be connected to a frac tank. The three-piece frac nut assembly 50 of FIG. 9 can be manufactured from raw materials or by sectioning an existing one-piece frac nut through its lugs and machining through-holes in each resulting half-lug 58 to define bolt holes (not shown) for securing the members 52, 54 and 56 together. Other aspects and advantages of the assembly 50 of FIG. 9 are consistent with the description of the assembly 10 of FIGS. 1 through 8.

While the invention has been described in terms of a specific embodiment, it is apparent that other forms could be adopted by one skilled in the art. For example, the frac nut assembly could differ in appearance and construction from the embodiment shown in the Figures, and various materials could be used in its construction. Therefore, the scope of the invention is to be limited only by the following claims.

1. A frac nut assembly adapted to be retained on a port fitting of a frac tank, the frac nut assembly having an annular shape, an outer circumferential surface, an interior surface having female threads thereon at one axial end of the frac nut assembly and a shoulder that extends radially inward from an opposite axial end of the frac nut assembly, and at least two lugs radially protruding from the outer circumferential surface, the frac nut assembly comprising:
at least two members that define the frac nut assembly when assembled together at planar radial interfaces, each of the members having an arcuate shape that forms a portion of the annular shape of the frac nut assembly, a radially outward surface defining a portion of the outer circumferential surface of the frac nut assembly, a radially inward surface having a shoulder fragment thereon that defines a portion of the shoulder of the frac nut assembly and thread fragments thereon that define a portion of the female threads of the frac nut assembly, at least two lug portions radially protruding from the radially outward surface thereof at opposite ends of the arcuate shape of the member so that when the members are assembled the lug portions define at least two of the lugs of the frac nut assembly, and two planar radial surfaces that are partially defined by the lug portions and are complementary to each other to define the planar radial interfaces of the members; and
means for fastening the lug portions of the members together.

2. The frac nut assembly according to claim 1, wherein the planar radial surfaces of the members uniformly mate in a surface-to-surface manner over their entire surfaces starting at the radially inward surfaces of the members and including the lug portions of the members.

3. The frac nut assembly according to claim 1, wherein the frac nut assembly consists of two of the members and the planar radial interfaces lie on a diameter of the frac nut assembly.

4. The frac nut assembly according to claim 1, wherein the frac nut assembly consists of more than two of the members and the planar radial interfaces lie on different radials of the frac nut assembly.

5. The frac nut assembly according to claim 4, wherein the fastening means comprises complementary through-holes through the lug portions and bolts received in the through-holes.

6. The frac nut assembly according to claim 5, wherein the bolts are entirely recessed below surfaces of the lug portions.

7. A method of securing the frac nut assembly of claim 1 to a port fitting of a frac tank, the method comprising:
positioning the members around the port fitting; and then
assembling the members together to form the frac nut assembly and so that the frac nut assembly is retained on the port fitting with a flange of the port fitting.

8. The method of claim 7, further comprising threadably connecting a fluid conduit to the port fitting by threading a male threaded fitting of the fluid conduit into the female threads of the frac nut assembly.
